(19) United States
(12) Patent Application Publication
(10) Pub. No.: US 2025/0111435 A1
(43) Pub. Date: Apr. 3, 2025

(54) Telesis

(71) Applicant: Steven Craig Boileau, Victoria (CA)

(72) Inventor: Steven Craig Boileau, Victoria (CA)

(21) Appl. No.: 18/376,227

(22) Filed: Oct. 3, 2023

(51) Int. Cl. G06Q 40/06

(52) U.S. Cl. CPC G06Q 40/06; G06Q 2230/00

(57) ABSTRACT

A novel system designed to allow a plurality of investors to manage investments in various investment propositions, mutual funds or a directly-owned portfolio of investments. The assets and liabilities of the mutual fund are adjusted in response to an action (buy, sell, trade) by one of the fund's members or participating investors in the system. The funds are dynamically managed, provide even and seamless funds distribution, promote self-authoring, and is extremely affordable and flexible.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This invention relates to Internet-based systems for engaging in financial investments. More particularly it relates to the creation of a fund, including, but not limited to, specifically a registered open-end investment company (a “mutual fund”), or a portfolio of directly-owned securities owned by an investor or a group of investors (such as an investment club) or managed by an adviser, where the preferences of the fund's or portfolio's own shareholders, or the participating investors to incest with various options.

### Description of the Related Art

Currently, investors have a few basic choices in terms of investing their money. They can manage their money themselves, or they can have someone else manage it for them. If they manage it themselves, they can obtain information from a variety of sources, including financial planners and advisers, brokers, and printed, on-line, or other materials. These sources allow investors managing their own money to do so with more or less specific information and advice provided to them. By investing in this manner, an investor retains the discretion to accept or reject the advice, and the investor makes the final investment decision.

In contrast, an investor can have someone else manage the investor's money for the investor, either by providing discretionary authority to a money manager or broker in an individual brokerage or other account managed for a specific investor, or by investing in a vehicle such as a mutual fund, a hedge fund, or some other collective investment

An investor who is a member of an investment club can have her investments managed in part by collective action by the members of the club where the members vote for the stocks to be purchased by the club. Those member actions are undertaken usually in meetings of the club, or occasionally on-line through e-mail or otherwise. They involve the collective selection of an investment, as opposed to the selection of investments that reflect aggregated, individual actions, even though, once selected, the investments, in both cases are held in a collective investment vehicle for all the investors. Put another way, in a typical managed mutual fund, investments are selected by a single or few money managers who determine the investments for all investors in the fund; in an investment club investments are selected by collective action (such as by voting or by designating a manager) of the relatively few members of the club, and investors must become members of the club by collective action.

The above-mentioned related patent applications describe inventions that allow smaller investors, through the alternative of a direct stock ownership system, to create portfolios that uniquely provide both the advantages of a mutual fund and of direct stock ownership. Using those inventions, a smaller investor can provide discretion to another, such as a financial planner or a money manager, to create and manage a portfolio of stocks for the smaller investor that is directly-owned by the investor. In that way, the smaller investor can obtain the benefits of “active management”—the benefits of having a professional manager make investment decisions to select the securities to be held in an investor's portfolio-while also maintaining the benefits of direct stock ownership.

The benefits of active management are generally among the benefits that many investors seek in an actively managed mutual fund where a professional fund manager—the fund adviser˜makes the active investment decisions for the fund as a whole. A smaller investor can also use the inventions described in the related applications to track a securities index, or an industry sector, using various selection criteria, thereby mimicking passively managed mutual funds like index funds. The above-mentioned related applications also describe a collaborative filtering technique that assists in the selection of securities to be included in the investor's portfolio by allowing investors to choose to follow the selections of a selected group of investors. The above-mentioned related applications also describe a means to create a portfolio for smaller investors that is limited by or satisfy certain parameters, such as minimum diversification and maximum-security issue concentration, so as to be useful as a substitute in 401 (k) or similar plans.

A frequently noted problem with actively-managed funds or professionally managed accounts is the so-called “herd” phenomenon. Professional managers of a mutual fund usually have styles, or the fund frequently has a “style”. For example, a fund could be a “growth” fund, seeking to invest in high growth stocks. Another fund may be an income fund, seeking to invest in high dividend stocks. When a stock is viewed as “growth,” the growth funds buy it, and similarly for other stocks and funds. Moreover, general trends in the economy are all followed by the same information sources, which report the same events and provide distribution means to the same commentators. Consequently, many professional managers hear and listen to the same things.

In addition, because many money managers are graded and reviewed based on how well they do relative to their peers, there is a tendency not to make investment choices that will be contrary to the decisions that one's peers will be making. It is better to try to be just slightly—but consistently—above average, than to run the risk of being a loser while trying to be a star. For these and other reasons, there is an observed phenomenon where the “smart” money follows the same investments, makes the same decisions, including the same mistakes, and usually performs less well, net of costs, on average than the market as a whole. The result is poorer performance from professionally-managed, actively-managed mutual funds than might otherwise be expected.

Under currently available offerings and the current art, an investor who does not wish to make his or her own investment decisions (or provide discretion to a broker or a money manager for an individualized account) can, very generally, either select to invest in a variety of passively-managed index funds or unit trusts, or select to invest in actively-managed mutual funds where the active management is supplied by a professional fund adviser. There is no way, however, for an investor to have a dynamic and changing actively-managed portfolio that reflects the aggregated, but individual, preferences of a plurality of investors, such as hundreds, thousands or millions of other people, and both as to the stocks in the portfolio and the proportion or weighting of the stocks in the portfolio.

Investing in an index fund is not the same. An index fund, like the S&P500 funds, invest in the “market” or some index and the fund increases or decreases in value depending on whether the “market” or the selected index rises or falls. At best, these funds reflect the investing public's preferences only to the degree the public's preferences are reflected in the upwards or downwards price of the specific stocks in the index and, therefore, in the fund—the investing public's preferences as to what should be held in the fund are irrelevant. An index fund does not vary in its weightings (except as the relative capitalization of the stocks themselves may change) or holdings (except when the index itself changes), and the holdings and the method of determining the weightings are dictated by those who specify the index (such as Standard & Poors, a division of McGraw Hill, for the S&P 500 funds). Even a fund that holds all of the stocks that are publicly traded will not have the weightings in the fund dictated by the preferences of investors, but by whether the stocks in the fund with the specific weightings chosen for the fund are increasing or decreasing in value.

Thus, the prior art does not provide for a fund that reflects the aggregated, individual preferences of a plurality of investors, and that varies its holdings and weightings to reflect changes in those preferences, Investors do not have the opportunity to invest in a dynamically-changing fund that is actively managed by the constantly and dynamically changing preferences of a plurality of investors, rather than by a professional manager. Similarly, investors who want their own portfolio (or a portfolio managed by another or held in an investment club) to be managed to reflect the constantly and dynamically changing individual, aggregated preferences of a plurality of investors, do not have any means to do so.

What is needed is a way for individuals to invest so that they can avail themselves of the advantages (e.g., economies of scale, active management) of a mutual fund without being subjected to the attendant disadvantages. What is needed is a way for an investor to invest in a mutual fund, or to have his or her own portfolio modified in a manner, that is actively managed by the constantly and dynamically changing individual preferences of a plurality of investors, rather than by a professional manager.

Therefore, the current invention seeks to provide a solution for this problem by creating an application that provides individuals with supplemented income from financiers who would like to see more of what may be recorded or rendered in life through a shared platform that acts as a simulation of auras for the mentation of qualities throughout a lexical framework.

Thus, there is a need in the prior art in which the aforementioned inconveniences, difficulties, and grooming problems are, for all practical purposes, eliminated. Thus, the present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

Embodiments of the invention relate to the presentation of an online system designed for a conditional basic income.

A prime objective of the present invention is to provide an improved form of the democratic system that allows for individualized voting on notions, movements, and ideas.

It is also the objective of the invention to provide an application that offers Financial distribution allowing interested members to finance private or public authors and their mentation faculty.

It is moreover the objective of the invention to provide a system that ameliorates fears or apprehensions about cyborgs through honoring roots in organic mentationalism.

Another very important object of the instant invention is the provision of the system designed after the hermetic principle of mentalism.

Yet another significant object of the invention is to provide a system that promotes good self-authoring and distribution of wealth.

Another objective of the invention is to provide an affordable system allowing to participate through affordable membership.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 shows the front interface of the invention.

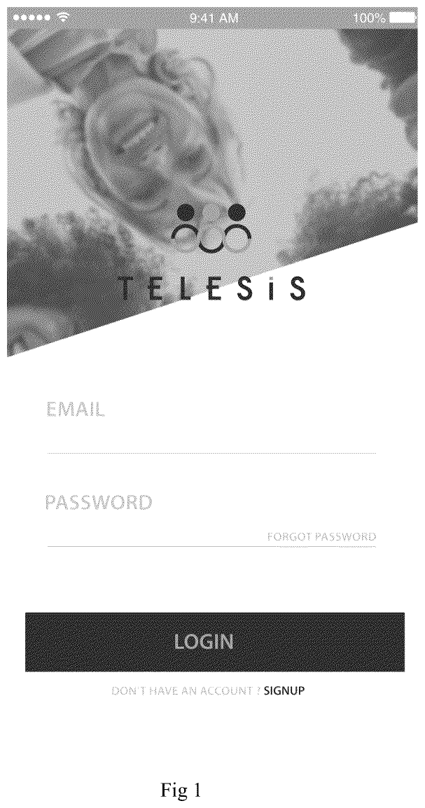

FIG. 2 shows the search engine feature of the software assembly.

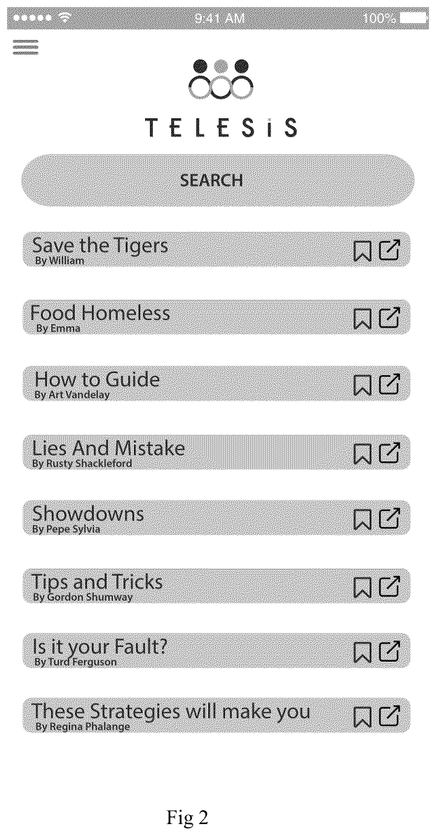

FIG. 3 shows the membership interface of the invention.

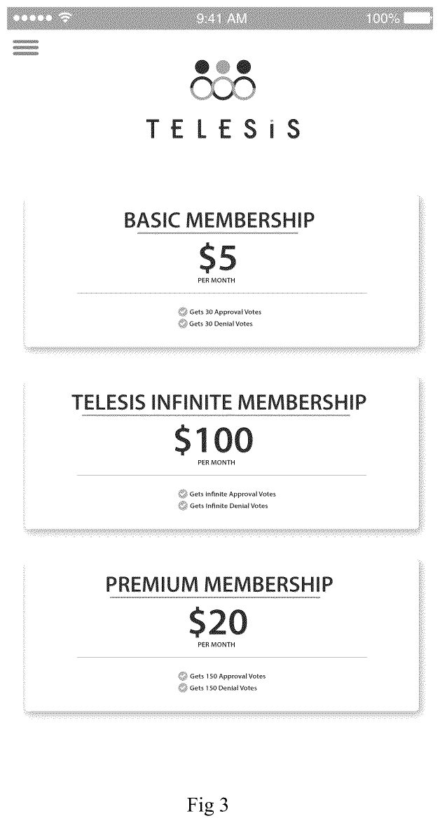

FIG. 4 shows the working interface of the invention.

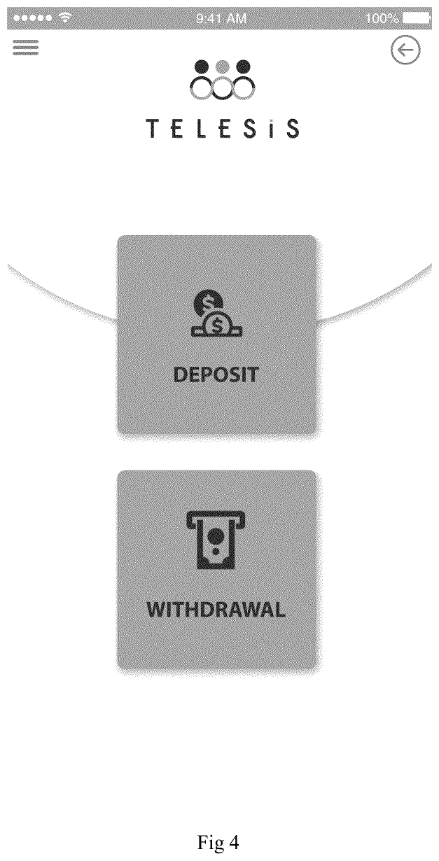

FIG. 5 shows the slider represent (Author vs Mentational Faculty) on the page of the invention.

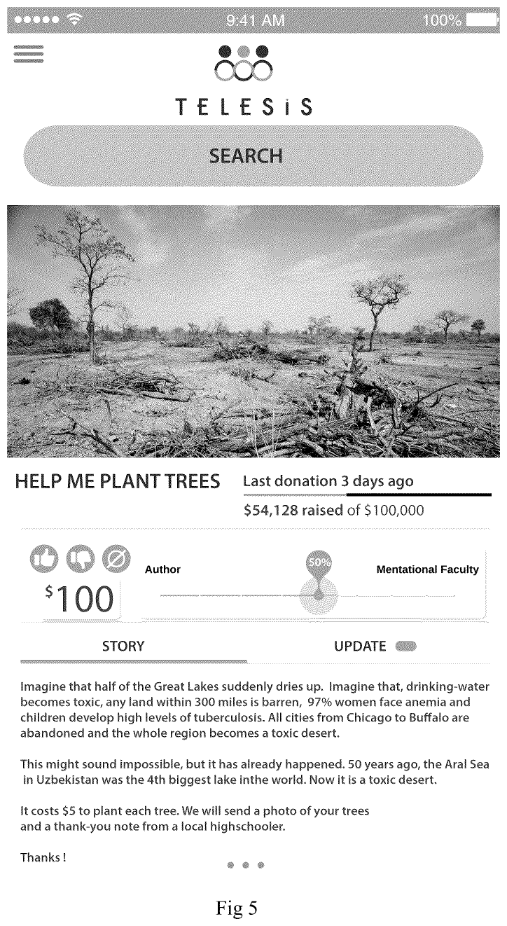

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before explaining the invention in detail, it is to be understood that the invention is not limited in its application to the detail of application illustrated in the drawings since the invention is capable of other embodiments and of being practiced or carried out in various ways. It is also to be understood that the phraseology or terminology employed is for the purpose of description only and not of limitation.

The current invention in its preferred embodiment discloses a method and system that is designed for a conditional basic income.

The current method proposes an unlimited number of people to interact with an unlimited number of other investors and create a “people's” mutual fund reflecting the interests and preferences of thousands or millions of different persons. The system aims to provide the first opportunity for investors to invest in dynamically-changing investment opportunities, that is actively managed and provides democratic platform, allowing individualized voting on notions, movements, and ideas.

The invention, can be viewed and used from a personal computer, laptop, PDA or any computing device. In order to use the web based application the user has to be connected to internet to provide the feedback and use features in real time. For real time utility needs to be connected to internet through local area networks (“LANs”)/wide area networks (“WANs”), wireless network or independent internet source. Further, the internet would connect the user to the online feedback application server, through the user's computing or mobile device, where applicable.

Generally, client device may include virtually any computing device capable of receiving and sending a message over a network, such as LAN/WAN or independent network, wireless network, and the like, to and from another computing device, such as server or mobile device, and the like. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, Tablets or PDAs. Similarly, client device may be any device that is capable of connecting using a wired or wireless communication medium such as a PDA, POCKET PC, wearable computer, and any other device that is equipped to communicate over a wired and/or wireless communication medium.

Client device may include a browser application that is configured to receive and to send web pages, web-based messages, and the like. The browser application may be configured to receive and display graphics, text, multimedia, and the like, employing virtually any web based language, including Standard Generalized Markup Language (SMGL), HyperText Markup Language (HTML), and so forth.

Client device may also include mobile computing devices especially the smartphone, which allow the user to download the application and use it on one click. The online website has a responsiveness mode for the application to function in full on the mobile computing device. Any mobile computing device can be used by the user for using the application. Such devices include portable devices such as, cellular telephones, smart phones, Personal Digital Assistants (PDAs), handheld computers, wearable computers, tablet computers, integrated devices combining one or more of the preceding devices, and the like.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An Internet-based supplemented income platform comprising a lexical framework allowing:
As per claim 1, the democratic system for individualized voting on notions, movements, and ideas.
As per claim 1, a seamless financial distribution allowing interested members to finance privately or publicly authors and their faculty.
As per claim 1, a specialized feature is designed after the hermetic principle of mentalism.
As per claim 1, a residual income platform acts as a Conditional Basic Income.
As per claim 1, a platform that supports the even distribution of wealth and promotes self-authoring.
